(19) United States
(12) Patent Application Publication
(10) Pub. No.: US 2014/0068865 A1
(43) Pub. Date: Mar. 13, 2014

(54) BACKBOARD WITH EXTENDABLE HANDLES FOR TRANSPORTING A PATIENT

(71) Applicant: EZ Lift Rescue Systems, Inc., Park City, UT (US)

(72) Inventor: Robert W. Heck, Park City, UT (US)

(73) Assignee: EZ Lift Rescue Systems, Inc., Park City, UT (US)

(21) Appl. No.: 13/779,215

(22) Filed: Feb. 27, 2013

Related U.S. Application Data
(60) Provisional application No. 61/604,828, filed on Feb. 29, 2012.

(51) Int. Cl. A61G 1/044; A61G 1/048

(52) U.S. Cl. CPC A61G 1/044; A61G 1/048
USPC 5/625

(57) ABSTRACT

A patient transportation device includes a backboard formed of or including structural foam with a solid skin exterior and a foamed core. A plurality of handles is removably coupled to the backboard. A plurality of straps is each coupled between plurality of handles and the backboard. Cartridges with retraction mechanisms can be received in channels in the backboard.

### PRIORITY CLAIM

Priority is claimed to U.S. Provisional Patent Application Ser. No. 61/604,828, filed Feb. 29, 2012, which is hereby incorporated herein by reference.

### CROSS-REFERENCE TO RELATED APPLICATION(S)

This is related to U.S. Design patent application Ser. No. 29/414,545, filed Feb. 29, 2012, which is hereby incorporated herein by reference.

### BACKGROUND

1. Field of the Invention

The present invention relates generally to a patient transport device or backboard with extendable and retractable handles to provide a lift from a safe lifting position at or above the knees.

2. Related Art

Emergency medical personnel, such as paramedics with ambulance services or fire departments, commonly transport victims or patients from an accident scene to a hospital. Backboards are commonly used to immobilize the spine of the patient during transport. Such backboards are typically flat, stiff boards that are sized to carry patients in a prone or supine position. Usually, these backboards have handles or handholds located around the periphery of the board. Thus, in use, a patient lies on the board and medical personnel lift the board with the patient to place them on a stretcher or gurney.

Because backboards are generally flat and only a few inches tall, lifting the board usually requires medical personnel to bend over, or squat down, near the board in order to grasp the handles of the board. Lifting a substantial load, such as a patient, from a bent or squatting position puts tremendous strain and loading on the back of the lifting personnel. Additionally, backboards often only need to be lifted to the height of a lowered gurney, or approximately eighteen inches, so that the gurney can be slid under the backboard to carry the patient.

Lifting a backboard to this height does not allow the medical personnel lifting the backboard to completely straighten up, but instead requires the lifter to remain in a bent or semi-bent position while sustaining the load of the patient until a gurney is placed under the backboard. Sustaining such a load in a bent position increases the strain on the lifters back and can result in injury to the lifter. Furthermore, medical personnel lifting in such a manner can become unstable or lose their balance and cause further injury to the patient.

Backboards with retractable and extendable handles have been proposed. For example, see U.S. Pat. No. 7,520,009.

### SUMMARY OF THE INVENTION

It has been recognized that it would be advantageous to develop a method and device that reduces the bending required by the lifter in order to lift a patient on a backboard. In addition, it has been recognized that it would be advantageous to develop a method and device to reduce back injuries or strain from lifting a patient on a backboard. In addition, it has been recognized that it would be advantageous to develop a method and device to lift a patient on a backboard onto a gurney. In addition it has been recognized that it would be advantageous to develop a backboard that is ergonomic, rigid, light-weight, and/or easy to assembly with extendable handles and retraction mechanisms.

The invention provides a patient transportation device with a backboard formed of or including structural foam with a solid skin exterior and a foamed core integrally and injection molded together from plastic with an expanding agent. One or more handles are removably coupled to the backboard. One or more straps are coupled between the handle and the backboard.

In accordance with a more detailed aspect of the invention, a channel can be formed in a bottom of the backboard on each of opposite sides of the backboard and facing downward. An elongated cartridge can be disposed in the channel in each of the opposite sides of the backboard. The cartridge can have an elongated hollow receiving the strap therein. A retraction mechanism can be disposed in the hollow of the cartridge and coupled to the strap to draw the strap into the hollow and the handle towards the backboard.

In addition, the invention provides a patient transportation device with a backboard having opposite ends, opposite sides and a concave upper surface. A channel is formed in a bottom of the backboard on each of the opposite sides of the backboard. A handle is removably coupled to the backboard by a strap. An elongated cartridge is disposed in the channel in each of the opposite sides of the backboard. The cartridge has an elongated hollow receiving the strap therein. A retraction mechanism is disposed in the hollow of the cartridge and coupled to the strap to draw the strap into the hollow and the handle towards the backboard.

Furthermore, the invention provides a patient transportation device with a backboard formed of or including structural foam with a solid skin exterior and a foamed core integrally and injection molded together from plastic with an expanding agent. The backboard has a perimeter rail formed around the perimeter of the backboard with opposite ends and opposite sides, and a web extending between the perimeter rail. The perimeter rail has an enlarged cross-sectional shape with respect to the interior web. A shelf is formed in each of the opposite ends and extends a width of the backboard and along a perimeter of the end and into a portion of the opposite sides of the backboard. The shelf extends into the backboard from a top of the backboard and the end. The shelf forms a bottom of the perimeter of the end of the backboard that is graspable and liftable. A handle is removably disposed on each shelf at each of the opposite ends. The handle fills the shelf along the width of the backboard. The handle is coupled to the backboard by a strap. A locking tab extends from the backboard at each of the opposite ends above the shelf with the handle disposed between the shelf and the tab. A channel is formed in a bottom of the backboard on each of the opposite sides of the backboard and facing downward. An elongated cartridge is disposed in each channel of each of the opposite sides of the backboard. The cartridge has an elongated hollow and a cross-section with an enlarged bottom abutting the bottom of the backboard and covering the channel. The perimeter rail is formed on the sides by the enlarged cross-sectional shape and the cartridges, and on the ends by enlarged cross-sectional shape and the handles. A spring block is fixed in each hollow of each cartridge for each handle. The spring block includes a body with a cross-sectional shape matching a cross-sectional shape of the hollow of the cartridge. A flange extends from the body, and a post extends from the flange. A continuous force coil spring is carried by each spring block and disposed on the post of the body of the spring block. An end block is fixed in each open end of each cartridge and has a passage therethrough. The end block includes a body with a cross-sectional shape matching a cross-sectional shape of the hollow of the cartridge. The passage extends longitudinally through the body of the end block and is aligned with the hollow of the cartridge to movably receive the strap therein. A shuttle is slidably disposed in each hollow of each cartridge at each end, and slidable between the spring block and the end block, and operatively coupled to the spring to be biased towards the spring block. The shuttle includes a body with a cross-sectional shape matching a cross-sectional shape of the hollow of the cartridge. A slot is in the body of the shuttle to receive the strap with an enlarged cavity to receive an end of the strap and a wedge therein. An opposite slot receives an end of the spring. A strap is coupled between the handle and the shuttle on each side of the handle. The handle is removable from the shelf of the backboard and draws the strap from the cartridge and displaces the shuttle in the hollow towards the open end against the spring so that the backboard can be suspended from the handle and the strap. The handle is replaceable on the shelf with the spring drawing the shuttle towards the spring block along with the strap.

### BRIEF DESCRIPTION OF THE DRAWINGS

Additional features and advantages of the invention will be apparent from the detailed description which follows, taken in conjunction with the accompanying drawings, which together illustrate, by way of example, features of the invention; and, wherein:

FIG. 1 is a perspective view of a patient transport backboard in accordance with an embodiment of the invention, shown with a handle in a retracted position;

FIG. 2 is a cross-sectional perspective view of the backboard of FIG. 1 taken along line 2 of FIG. 1;

FIG. 3 is a cross-sectional end view of the backboard of FIG. 1 taken along line 2 of FIG. 1;

FIG. 4 is a partial cross-sectional end view of the backboard of FIG. 1;

FIG. 5 is a partial cross-sectional perspective view of the backboard of FIG. 1 taken along line 5 of FIG. 2;

FIG. 6 is a partial cross-sectional perspective view of the backboard of FIG. 1 taken along line 6 of FIG. 2;

FIG. 7 is a partial perspective view of the backboard of FIG. 1, shown with the handle removed;

FIG. 8 is a perspective view of the handle of the backboard of FIG. 1;

FIG. 9 is a partial side view of the backboard of FIG. 1, shown with the handle removed;

FIG. 10 is an exploded perspective view of the backboard of FIG. 1, showing a cartridge removed from the backboard and components of a retraction mechanism removed from the cartridge;

FIG. 11 is a partial exploded perspective view of the backboard of FIG. 1;

FIG. 12 is a partial cross-sectional perspective view of the backboard of FIG. 1 taken along line 12 of FIG. 1;

FIG. 13 is a perspective view of a stopper of the backboard of FIG. 1;

FIG. 14 is a perspective view of a end block of the backboard of FIG. 1;

FIG. 15 is a perspective view of a shuttle of the backboard of FIG. 1;

FIG. 16 is a perspective view of a spring block of the backboard of FIG. 1;

FIG. 17 is a perspective view of a coil spring of the backboard of FIG. 1;

FIG. 18 is a perspective view of the shuttle coupled to the coil spring and a strap of the backboard of FIG. 1;

FIG. 19 is a perspective view of a retraction assembly of the backboard of FIG. 1 showing the spring block, the coil spring, the shuttle, the strap, and the end block;

FIG. 20 is a perspective view of a handle coupled to retraction assemblies of the backboard of FIG. 1;

FIG. 21 is a partial perspective view of a cartridge of the backboard of FIG. 1; and

FIG. 22 is a partial side view of the backboard of FIG. 1, shown with the handle extended and in a lifting position.

Reference will now be made to the exemplary embodiments illustrated, and specific language will be used herein to describe the same. It will nevertheless be understood that no limitation of the scope of the invention is thereby intended.

### DETAILED DESCRIPTION OF EXAMPLE EMBODIMENT(S)

Firefighters and Emergency Medical Services (EMS) personnel must perform a wide array of potentially hazardous emergency rescue procedures that often include lifting patients at a trauma scene from the ground to a gurney. The use of traditional backboards requires that firefighters or EMS personnel lift from the ground to get a patient onto the gurney at an accident scene. Lifting patients from the ground place rescuers at risk for injury from muscle strain caused by poor body position for lifting, poor body mechanics, and maximum torque on the lower back.

The patient transportation backboard with extendable handles of the present invention allows firefighters/EMS responder personnel to lift from a safe lifting position at or above the knees which dramatically reduces torque on the lower back where most injuries occur by raising the lift from the danger zone below the knees to a point at or slightly above the knees—in the safe lifting zone. It is believed that the present backboard provides a reduction of more than 50% torque on the lower back compared to a traditional backboard lift. The backboard can be used in a variety of configurations giving firefighter/EMS personnel the flexibility to address any lift situation with mini-mum back stress. The backboard can have a size of 72″×16″×2″ thick, and a weight of less than 19 lbs. for low profile storage in firefighter and EMS vehicles. The backboard can be formed from high density polyethylene (HDPE) structural foam that is 100% X-Ray translucent (compatible with imaging equipment) and ergonomically designed for improved patient comfort, stability, and un-weighting typical pressure points. In addition, the backboard can support many accessory options, including the head bed, built in spider web strap system for patient immobilization, wheels for patient trans-port over rough terrain, footrest, SingleTrac Rescue System and accessories, and additional lifting straps.

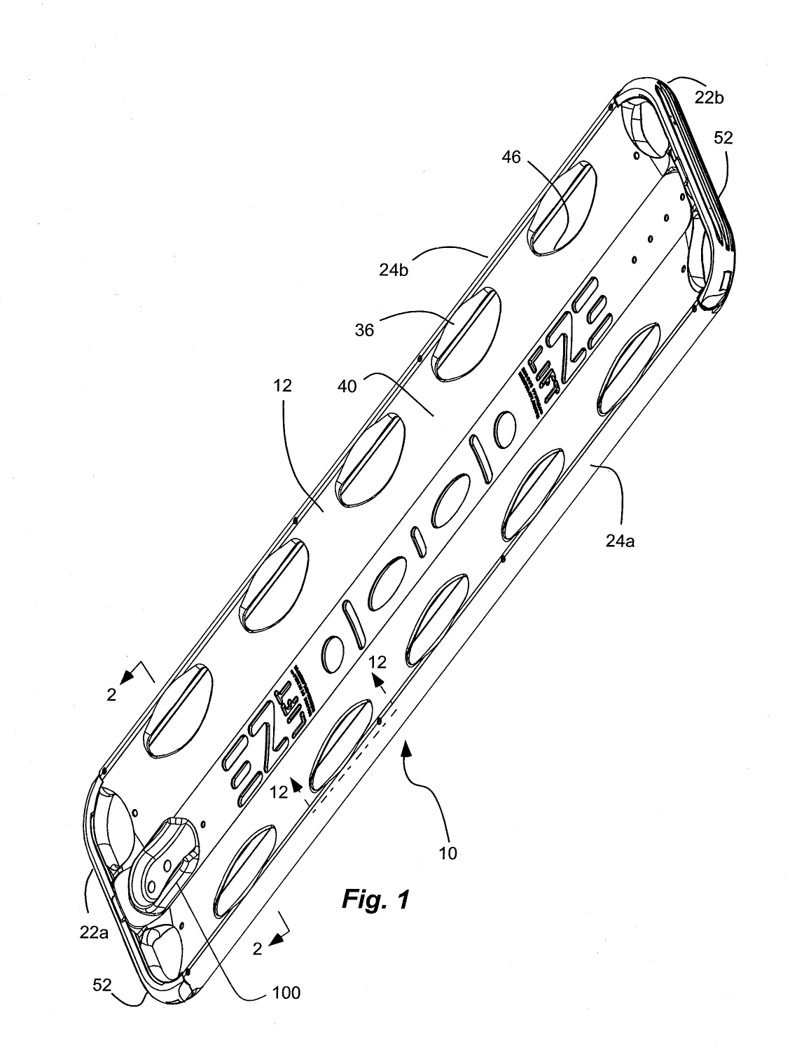

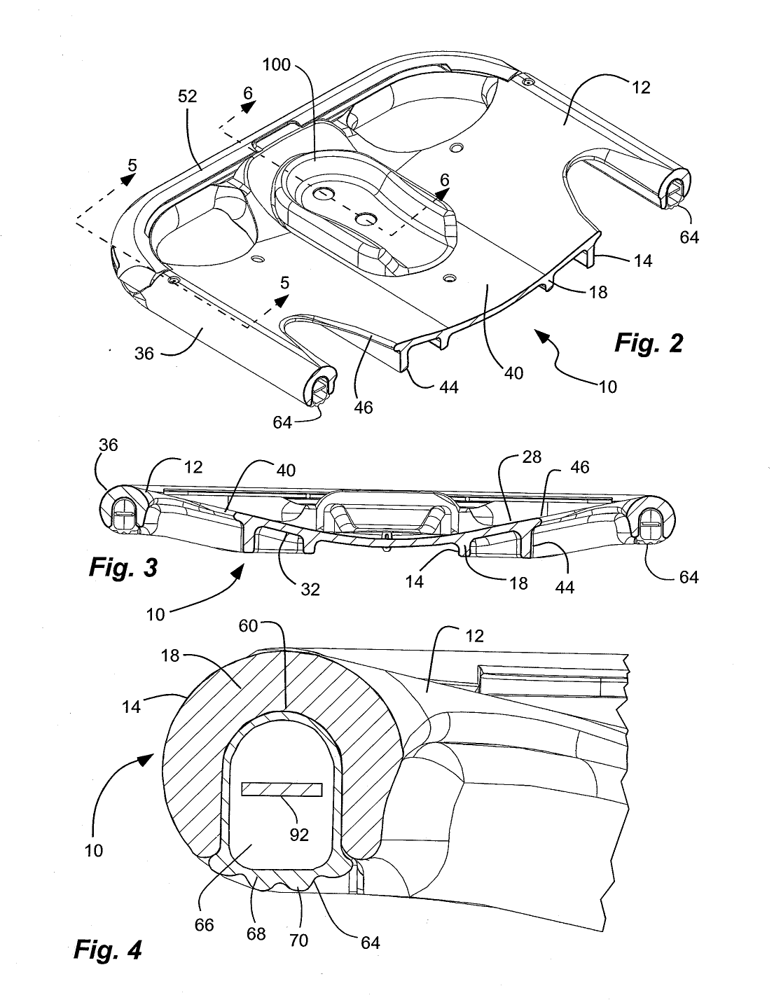

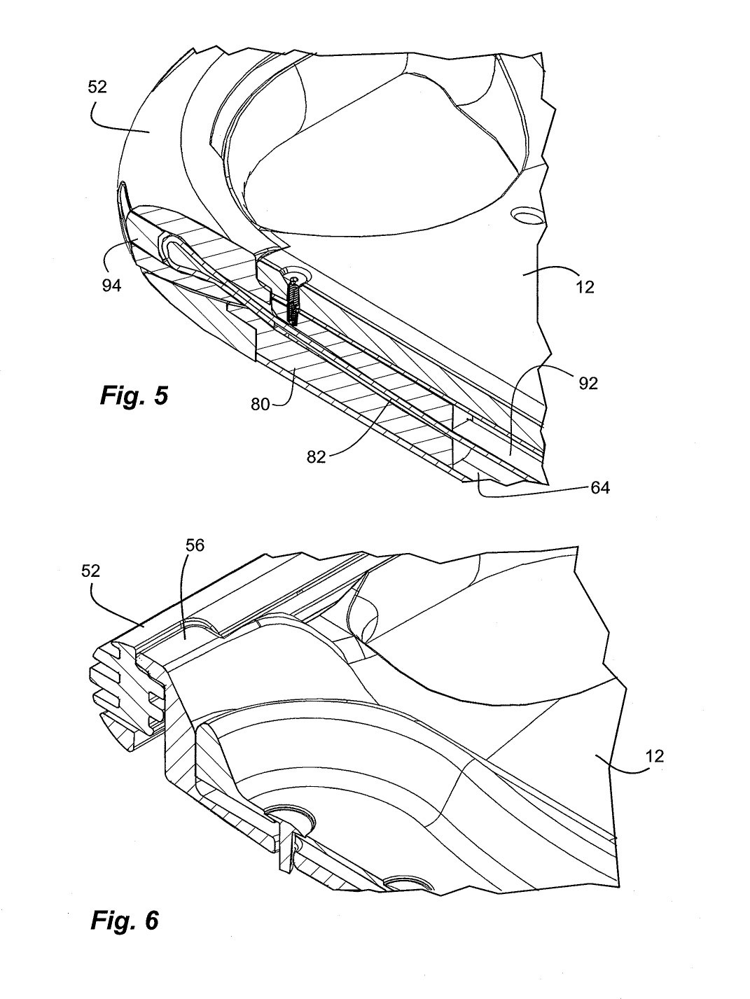

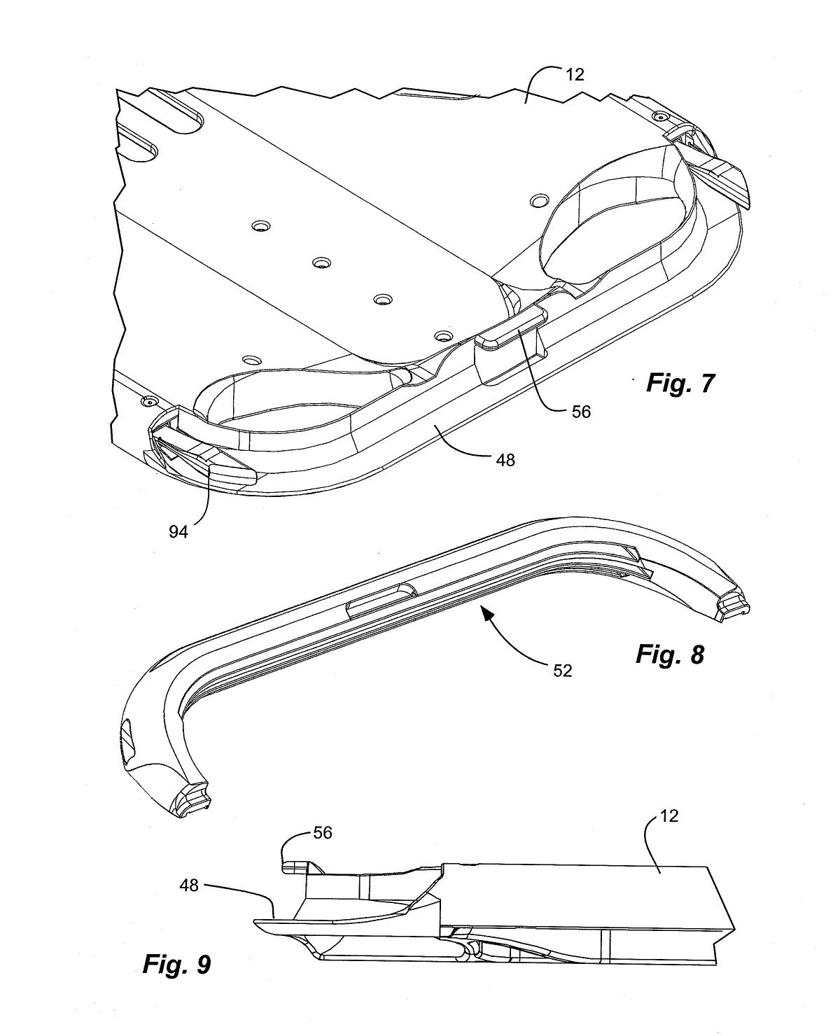

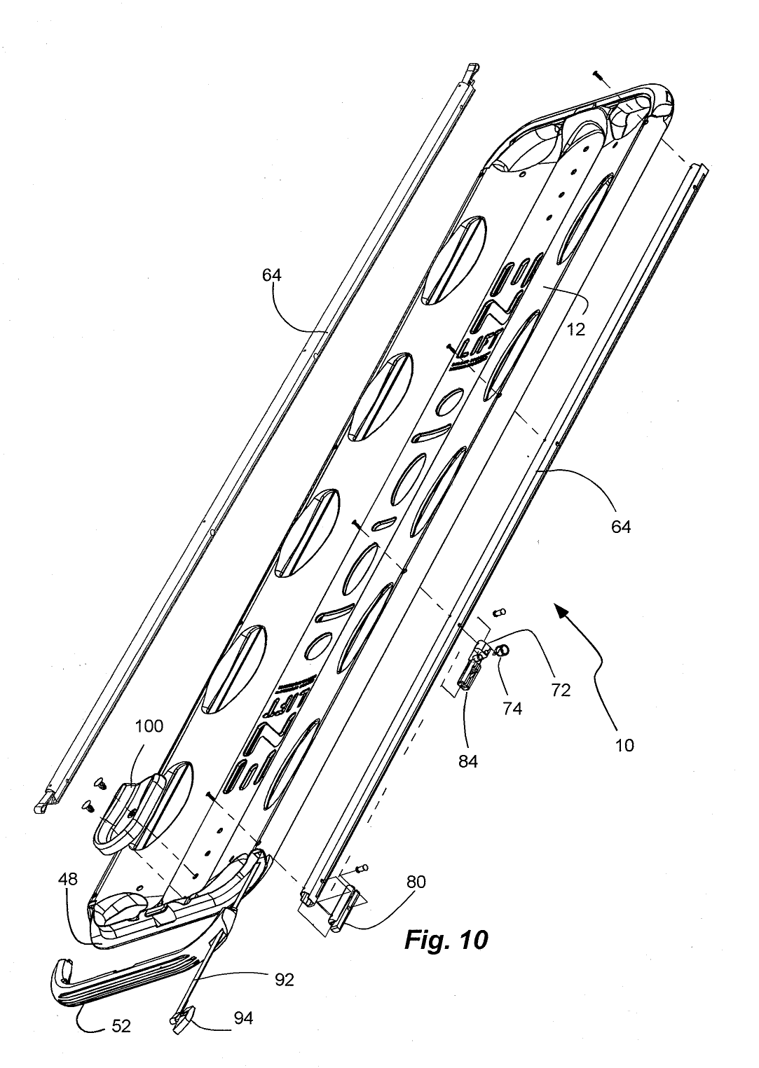

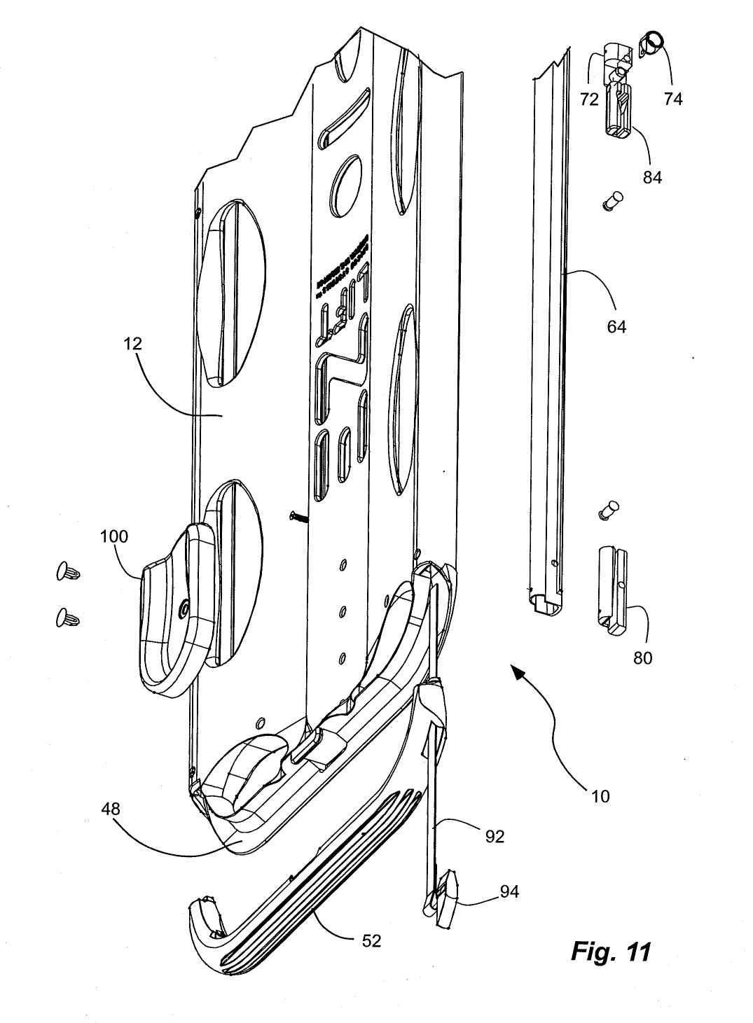

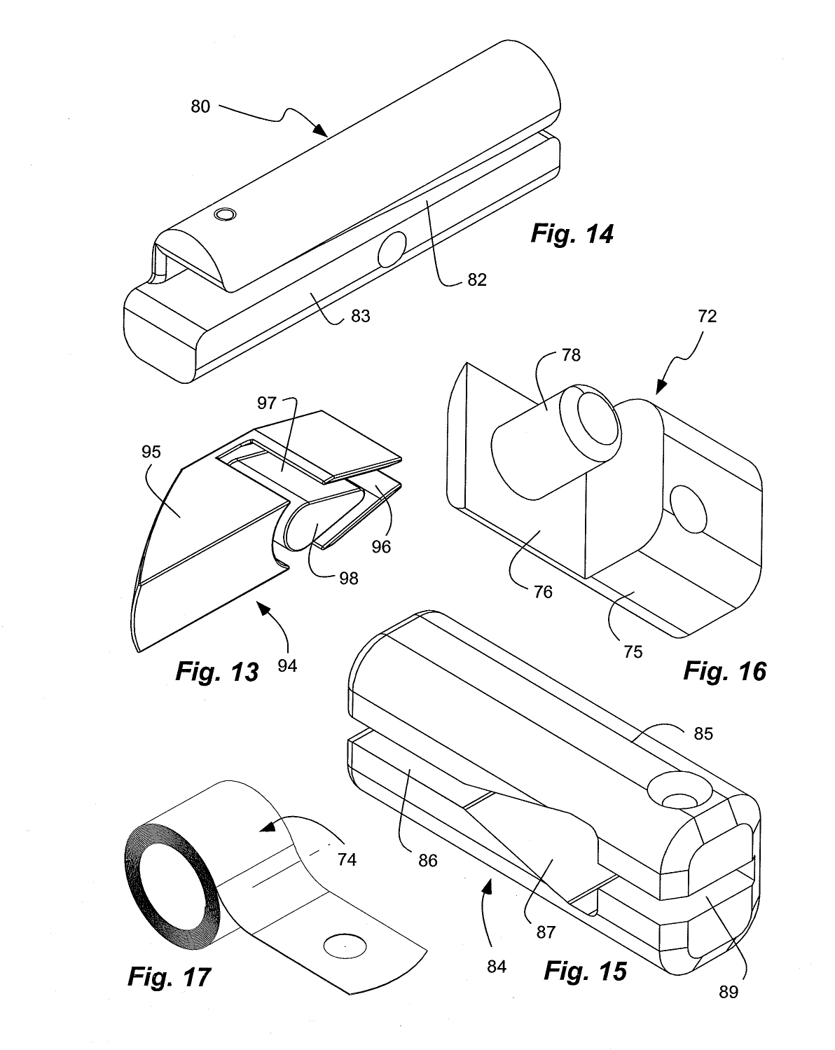

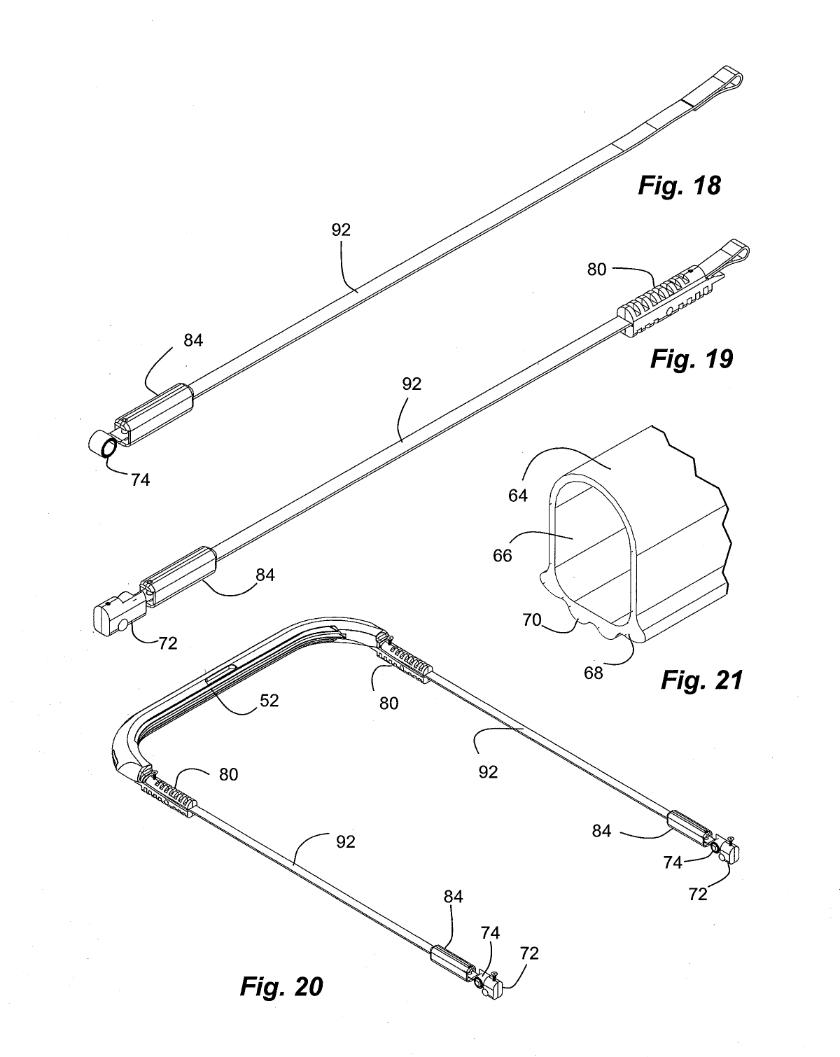

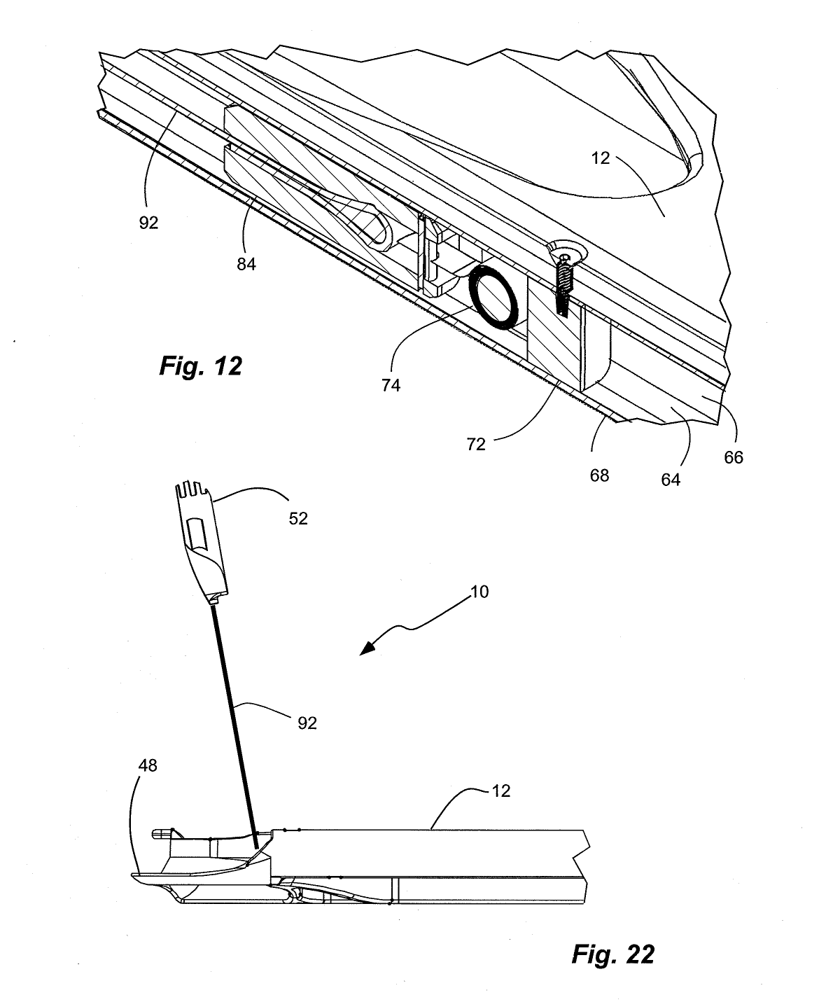

As illustrated in FIGS. 1-22, a patient transport device or backboard, indicated generally at 10, in an example implementation in accordance with the invention is shown with extendable and retractable handles to provide personnel the ability to lift the backboard with patient thereon from a safe lifting position at or above the knees, which dramatically reduces torque on the lower back. The patient transportation device or backboard 10 includes a backboard or bed 12 formed of or including structural foam with a solid skin exterior 14 and a foamed core 18 integrally formed together and injection molded together from plastic with an expanding agent. The backboard can be formed by a low-pressure injection molding process in which the plastic material is injected into a mold after being mixed with an expanding agent, a blowing agent or high-pressure gas. Bubbles are produced in the plastic causing it to foam. The foam can retain the properties of the plastic while weighing less due to reduced density. The backboard or bed can be rigid with a hard surface. The plastic can be high density polyethylene (HDPE).

The backboard 10 has opposite ends 22a and 22b and opposite sides 24a and 24b. In addition, the backboard 10 has a concave upper surface or top 28 and a convex lower surface or bottom 32. The backboard 10 also has a perimeter rail 36 extending around a perimeter of the backboard. The perimeter rail 36 can include the opposite sides 22a and 22b and the opposite ends 24a and 24b. An interior web 40 can extend between the perimeter rail 36, and the opposite sides 22a and 22b and the opposite ends 22a and 22b. The perimeter rail 36 can have an enlarged or thicker cross-sectional shape with respect to the web 40. In addition, the perimeter rail 36 can have a bulbous or round cross-sectional shape to form a handle or grip. The web 40 can be thinner than the enlarged sides or rails. In addition, the web 40 can extend from a top of the opposite sides or rails to an intermediate portion below the opposite sides. Furthermore, flanges 44 can extend out from a bottom of the webs. The flanges 44 can extend longitudinally and/or laterally across the web, and substantially vertically and downward from the web. The flanges 44 can extend below the opposite sides of the backboard or the rail so that the rail is elevated to facilitate grasping. Thus, when disposed on a support surface, a gap can be formed between the rail and the support surface. A plurality of perimeter apertures 46 can be formed in the backboard or bed adjacent to the sides or rails to form grips for a user to grip the sides or rails.

A shelf 48 is formed in each of the opposite ends 22a and 22b and extends a width of the backboard 12. In addition, the shelf 48 extends along a perimeter of the end and into a portion of adjacent sides or rails of the backboard. Furthermore, the shelf extends into the backboard from a top of the backboard (or rail) and the end. The ends can also include a rail, with the shelf formed therein. The shelf 48 forms a bottom perimeter of the backboard at the end of the backboard that is graspable and liftable. The shelf can have a horizontal U-shape.

A handle 52 is removably disposed on the shelf 48 in each of the opposite ends 22a and 22b. Thus, the backboard 12 can have a pair of handles, with one on each end. The handle 52 can fill the shelf along the width of the backboard 12 so that the handle can be grasped by both hands of a lifter, or by a pair of lifters on opposite sides of the handle and backboard. The handle 52 can fill the shelf 48 or the indentation formed by the shelf in the rail 36 at the ends of the backboard so that the handle and shelf can together form a grip. The handle 52 can have a U-shape that matches the shelf 48, and a width that matches the width of the backboard. Ends of the handle 52 can be parallel with and aligned with the sides or rails of the backboard. A locking tab 56 can extend from the backboard 12 at each of the opposite ends 22a and 22b above the shelf 48. The handle 52 can be disposed between the shelf 48 and the tab 56 when retracted to maintain the handle to the backboard. The shelf 48 and the tab 56 can provide an interference fit with the handle to retain the handle. The locking tab 56 can extend horizontally parallel with the shelf so that the handle is withdrawn horizontally and longitudinally with respect to the backboard. The handle can have a recess that receives the locking tab when the handle is retracted.

An elongated channel 60 is formed in a bottom of the backboard 12 or rails 36 on each of the opposite sides 24a and 24b of the backboard. Thus, the backboard has a pair of channels with one on each side. The channels 60 can extend almost all of the length of the backboard 12 between the handles 52. The channels 60 face downward or are open downward. As described above, the opposite sides or rails have a bulbous or round cross-sectional shape. The channels 60 have an inverted U-shape, or cross-sectional shape, formed in the bottom of the sides or rails. An aperture is formed in the backboard between the end of the channel and the end of the shelf.

An elongated cartridge 64 is disposed in the channel 60 in each of the opposite sides 24a and 24b or rails 36 of the backboard 12. Thus, the backboard has a pair of cartridges, with one on each side and one in each channel. The cartridges 64 contain the retraction mechanism or means for withdrawing and/or retracting the handles. The retraction mechanism can be disposed in a hollow of the cartridge and coupled to a strap to draw the strap into the hollow and the handle towards the backboard or shelf. The cartridges can be discrete units that can be assembled and removed and replaced from the backboarad.

The cartridges 64 have an elongated hollow 66 and a cross-section with an enlarged bottom 68 abutting the bottom of the backboard and covering the channel 60. The elongated cartridges 64 also have a cross-sectional shape with an upper inverted U-shape matching and filling the channel 60. The enlarged bottom 68 can be substantially flush with the bulbous or round cross-sectional shape of the sides, and/or can extend beyond the channel. The bottom 68 of the cartridge can have an exposed surface or face that compliments or fills the bulbous or round cross-sectional shape of the sides or rails, so that together the rails 36 and cartridge 64, or bottom 68 thereof, provide the bulbous or round shape. In addition, ribs 70 can be formed in the bottom 68 and exposed surface or face of the cartridge to facilitate grasping. The ribs 70 can extend longitudinally along a length of the cartridge. The cartridge can be formed as an elongated extrusion.

As described above, a perimeter rail 36, with an enlarged cross-sectional shape with respect to the interior web 40, is formed around the perimeter of the backboard 12. The perimeter rail 36 can be formed by the backboard 12 and the cartridges 64 on the sides 24a and 24b, and the backboard 12 and the handles 52 at the ends 22a and 22b and corners. The backboard can form a majority of the rail or enlarged cross-section thereof, with the cartridges and/or handles completing a perimeter of the cross-sectional shape.

A spring block 72 is fixed in each hollow 66 of each cartridge 64 for each handle 52. Thus, four spring blocks can be provided, two for each handle, with two spring blocks in each cartridge. The spring blocks 72 can be disposed in the middle or intermediate section of the channels. The spring block 72 can carry a continuous force coil spring 74. The spring block 72 can have a body 75 with a cross-sectional shape matching a cross-sectional shape of the hollow of the cartridge. A flange 76 can extend from the body 75 in a longitudinal direction. A post 78 can extend from the flange 76 transverse to the longitudinal axis to receive the spring 74. The coil spring can be coiled around the post. The spring block can be molded from plastic, and can be affixed in the hollow of the cartridge with a screw or other fastener or adhesive.

An end block 80 is fixed in each open end of each cartridge 64. Thus, four end blocks can be provided, two for each handle, and two in each cartridge. The block 80 has a passage 82 therethrough to movably receive a strap therein (as described below). The end block 80 includes a body 83 with a cross-sectional shape matching a cross-sectional shape of the hollow 66 of the cartridge 64. The passage 82 extends longitudinally through the body 83 and is aligned with the hollow 66 of the cartridge 64 to movably receive the strap therein. The end block can be molded from plastic, and can be affixed in the hollow or opening of the cartridge with a screw of other fastener or adhesive.

A shuttle 84 is slidably disposed in each hollow 66 of each cartridge 64 and is slidable between the spring block 72 and the end block 80. Thus, four shuttles can be provided, two for each handle, and two for in each cartridge. The shuttle 84 can be operatively coupled to the spring 74, such as a distal end of the spring, to be biased towards the spring block 72. A distal or free end of the spring can be coupled to the shuttle. The shuttle 84 can include a body 85 with a cross-sectional shape that can match a cross-sectional shape of the hollow 66 of the cartridge 64. A slot 86 can be formed in the body 85 to receive the strap with an enlarged cavity 87 to receive an end of the strap wrapped around a wedge. An opposite slot 89 can receive an end of the spring 74. The shuttle can be molded from plastic. The hollow and the bodies can be shaped to maintain orientation of the bodies in the hollow.

A strap 92 is coupled between the handle 52, or opposite ends thereof, and the shuttles 84 on each side of the handle. The handle can include a slot or bore to receive the strap therein or therethrough. The end of the strap 92 can be coupled to a stopper 94 retained in the slot or bore of the handle. The stopper 94 includes a body 95 with a slot 96 to receive the strap with an enlarged cavity 97 to receive an end of the strap wrapped around a wedge 98. The stopper can be molded of plastic and can wedge into the slot or bore of the handle. In addition, the stopper can have a face plate that is flush with the handle.

The handle 52 is removable from the shelf 48 of the backboard 12, drawing the strap 92 from the cartridge 64 and displacing the shuttle 84 in the hollow 66 towards the open end against the spring 74, so that the backboard 12 can be suspended from the handle 52 and the strap 92. The handle 52 is replaceable on the shelf 48, and retractable with respect to the backboard, with the spring 74 drawing the shuttle 84 towards the spring block 72 along with the strap 92.

Each cartridge 64 can include two retraction mechanisms, for one side of each handle, to retract the handle and straps. Thus, each cartridge 64 can have a pair of end blocks 80, one in each of the opposite open ends thereof, and a pair of spring blocks 72 in the interior or midsection thereof. An end block 80 and a spring block 72 can be paired together or can correspond with one another to provide stops to a corresponding shuttle 84. The end blocks 80 and spring blocks 72 can be secured in the hollow 66 and to the cartridges 64 with fasteners, such as screws. In addition, each cartridge 64 can have a pair of shuttles 84, each coupled to the spring 74 of one of the spring block 72, and slidable between one of the spring blocks 72 and one of the end blocks 80. A pair of straps 92 can have one proximal end coupled to the shuttle 84 and another distal end extending from the open ends of the cartridge 64 (and through the passage 82 in the end block 80) to be coupled to an end or side of the handle 52, and/or stopper 94 thereof. The strap 92 can be coupled to the shuttle 84 and the handle 52 or stopper 94 by extending around a wedge. Thus, force on the strap pulls the wedge into the narrower portion of the cavity and against the strap. The cartridge 64 with the end blocks 80, the spring blocks 72 and springs 74, shuttles 84, and straps 92 (and wedges) form a cartridge assembly that can be inserted into the channels 60 of the rails 36 or sides 24a and 24b. The cartridge assembly can be secured with a press or interference fit and/or fasteners, such as screws, or an adhesive.

The device or backboard can have one or more accessories. A head brace 100 can be coupled to the upper surface of the backboard at one end thereof. The head brace has a concave indentation in an upward surface thereof at least partially surrounded by a perimeter protrusion. A foot rest can be coupled to the upper surface of the backboard at one end thereof. A knee pyramid can be coupled to the upper surface of the backboard intermediate the opposite ends. An IV pole can coupled to a hole in the backboard. The IV pole can include a battery powered light. A light can be coupled to the backboard, such as by a hole in the backboard. A dolly can be coupled to the backboard and can be capable of carrying the backboard with the dolly rolling on the ground. Balloon wheels can be coupled to the backboard. A retention system of straps and/or a web can be coupled to the sides of the backboard to extend over a patient on the backboard.

The backboard can be formed of or can include high density polyethylene (HDPE) structural foam that can be formed by a low-pressure injection molding process in which the plastic material is injected into a mold after being mixed with a blowing agent or high-pressure gas. The handle, cartridge, spring block, end block, shuttle, and wedge can be formed of nylon, such as Dupont Zytel, and can be formed by injection molding. The strap can be formed of webbing or belt, such as polyester webbing or belt. The cartridge can be formed by extrusion.

Although the backboard has been described above and shown herein as having a pair of cartridges in a pair of channels, the backboard can have four cartridges in four channels, each corresponding to an end of a handle.

In use, the backboard 10 can be disposed on the ground or other support surface. A patient can be disposed on and secured to the backboard, such as with straps. Two or more user's or lifters can grasp the handles and remove it from the shelf. The handles can be extended so that they are elevated above the backboard. The two or more lifters can squat at the knee while keeping their backs straight, due to the extended and elevated handles, and lift the backboard with the patient thereon.

Various aspects of a backboard with retractable and extendable handles are shown in U.S. Pat. No. 7,520,009, which is herein incorporated by reference.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. A patient transportation device, comprising:
a) a backboard formed of or including structural foam with a solid skin exterior and a foamed core integrally and injection molded together from plastic with an expanding agent;
b) a handle removably coupled to the backboard; and
c) a strap coupled between the handle and the backboard.

2. A device in accordance with claim 1, further comprising:
a) a web extending between opposite sides of the backboard;
b) flanges extending out from a bottom of the web; and
c) opposite sides of the backboard having an enlarged cross-sectional shape with respect to the web.

3. A device in accordance with claim 2, wherein the web extends from a top of the opposite sides to an intermediate portion below the opposite sides.

4. A device in accordance with claim 2, wherein the flanges extend substantially vertically downward below the opposite sides of the backboard.

5. A device in accordance with claim 1, further comprising:
a) a channel formed in a bottom of the backboard on each of opposite sides of the backboard and facing downward; and
b) an elongated cartridge disposed in the channel in each of the opposite sides of the backboard, the cartridge having an elongated hollow receiving the strap therein.

6. A device in accordance with claim 5, further comprising:
a retraction mechanism disposed in the hollow of the cartridge and coupled to the strap configured to draw the strap into the hollow and the handle towards the backboard.

7. A device in accordance with claim 5, wherein the backboard comprises:
a) the opposite sides having a bulbous or round cross-sectional shape with the channel formed in the bottom thereof; and
b) the elongated cartridge having cross-sectional shape with an upper matching and filling the channel, and an enlarged bottom extending beyond the channel.

8. A device in accordance with claim 5, further comprising ribs formed in a bottom of the cartridge to facilitate grasping.

9. A device in accordance with claim 5, further comprising:
a) a perimeter rail formed around the perimeter of the backboard;
b) a web extending between the perimeter rail; and
c) the perimeter rail having an enlarged cross-sectional shape with respect to the interior web.

10. A device in accordance with claim 9, further comprising:
the perimeter rail formed by opposite sides of the backboard having an enlarged cross-sectional shape and the cartridges on the sides, and by opposite ends of the backboard and opposite handles at the ends.

11. A device in accordance with claim 5, further comprising:
a) the cartridge having an elongated hollow and a cross-section with an enlarged bottom abutting the bottom of the backboard and covering the channel;
b) a spring block fixed in the hollow of the cartridge;
c) a continuous force coil spring carried by the spring block;
d) an end block fixed in an open end of the cartridge and having a passage therethrough;
e) a shuttle slidably disposed in the hollow of the cartridge and slidable between the spring block and the end block, and operatively coupled to the spring to be biased towards the spring block;
f) a strap coupled between the handle and the shuttle; and
g) the handle being removable from the backboard and drawing the strap from the cartridge and displacing the shuttle in the hollow towards the open end against the spring so that the backboard can be suspended from the handle and the strap, and the handle being replaceable with the spring drawing the shuttle towards the spring block along with the strap.

12. A device in accordance with claim 11, wherein the spring block comprises:
a) a body with a cross-sectional shape matching a cross-sectional shape of the hollow of the cartridge;
b) a flange extending from the body; and
c) a post extending from the flange to receive the spring.

13. A device in accordance with claim 11, wherein the end block comprises:
a) a body with a cross-sectional shape matching a cross-sectional shape of the hollow of the cartridge; and
b) the passage extending longitudinally through the body and aligned with the hollow of the cartridge to movably receive the strap therein.

14. A device in accordance with claim 11, wherein the shuttle comprises:
a) a body with a cross-sectional shape matching a cross-sectional shape of the hollow of the cartridge;
b) a slot in the body to receive the strap with an enlarged cavity to receive an end of the strap and a wedge therein; and
c) an opposite slot to receive an end of the spring.

15. A device in accordance with claim 11, wherein the handle comprises:
a slot to receive the strap with an enlarged cavity to receive an end of the strap and a wedge therein.

16. A device in accordance with claim 1, further comprising:
a) a shelf formed in an end of the backboard and extending a width of the backboard and along a perimeter of the end and into a portion of adjacent sides of the backboard, the shelf extending into the backboard from a top of the backboard and the end, the shelf forming a bottom perimeter of the backboard at the end of the backboard that is graspable and liftable;
b) the handle removably disposed on the shelf in the end of the backboard, the handle filling the shelf along the width of the backboard; and
c) a locking tab extending from the backboard at the end above the shelf with the handle disposed between the shelf and the tab.

17. A device in accordance with claim 1, wherein the handle extends a width of the backboard and has a horizontal U-shape with ends parallel and aligned with sides of the backboard.

18. A patient transportation device, comprising:
a) a backboard having opposite ends, opposite sides and a concave upper surface;
b) a channel formed in a bottom of the backboard on each of the opposite sides of the backboard;
c) a handle removably coupled to the backboard by a strap;
d) an elongated cartridge disposed in the channel in each of the opposite sides of the backboard, the cartridge having an elongated hollow receiving the strap therein; and
e) a retraction mechanism disposed in the hollow of the cartridge and coupled to the strap configured to draw the strap into the hollow and the handle towards the backboard.

19. A device in accordance with claim 18, further comprising:
a) a shelf formed in each of the opposite ends and extending a width of the backboard and along a perimeter of the end and into a portion of the opposite sides of the backboard, the shelf extending into the backboard from a top of the backboard and the end, the shelf forming a bottom of the perimeter of the end of the backboard that is graspable and liftable;
b) the handle being removably disposed on each shelf at each of the opposite ends, the handle filling the shelf along the width of the backboard;
c) a locking tab extending from the backboard at each of the opposite ends above the shelf with the handle disposed between the shelf and the tab;
d) a spring block fixed in each hollow of each cartridge for each handle;
e) a coil spring carried by each spring block;
f) an end block fixed in each open end of each cartridge and having a passage therethrough;
g) a shuttle slidably disposed in each hollow of each cartridge at each end and slidable between the spring block and the end block, and operatively coupled to the spring to be biased towards the spring block;
h) the strap coupled between the handle and the shuttle on each side of the handle; and
i) the handle being removable from the shelf of the backboard and drawing the strap from the cartridge and displacing the shuttle in the hollow towards the open end against the spring so that the backboard can be suspended from the handle and the strap, and the handle being replaceable on the shelf with the spring drawing the shuttle towards the spring block along with the strap.

20. A patient transportation device, comprising:
a) a backboard formed of or including structural foam with a solid skin exterior and a foamed core integrally and injection molded together from plastic with an expanding agent, and having a perimeter rail formed around the perimeter of the backboard with opposite ends and opposite sides, a web extending between the perimeter rail, the perimeter rail having an enlarged cross-sectional shape with respect to the interior web;
b) a shelf formed in each of the opposite ends and extending a width of the backboard and along a perimeter of the end and into a portion of the opposite sides of the backboard, the shelf extending into the backboard from a top of the backboard and the end, the shelf forming a bottom of the perimeter of the end of the backboard that is graspable and liftable;
c) a handle removably disposed on each shelf at each of the opposite ends, the handle filling the shelf along the width of the backboard, the handle coupled to the backboard by a strap;
d) a locking tab extending from the backboard at each of the opposite ends above the shelf with the handle disposed between the shelf and the tab;
e) a channel formed in a bottom of the backboard on each of the opposite sides of the backboard and facing downward;
f) an elongated cartridge disposed in each channel of each of the opposite sides of the backboard, the cartridge having an elongated hollow and a cross-section with an enlarged bottom abutting the bottom of the backboard and covering the channel;
g) the perimeter rail formed on the sides by the enlarged cross-sectional shape and the cartridges, and on the ends by enlarged cross-sectional shape and the handles;
h) a spring block fixed in each hollow of each cartridge for each handle, the spring block including a body with a cross-sectional shape matching a cross-sectional shape of the hollow of the cartridge, a flange extending from the body, and a post extending from the flange;
i) a continuous force coil spring carried by each spring block and disposed on the post of the body of the spring block;
j) an end block fixed in each open end of each cartridge and having a passage therethrough, the end block including a body with a cross-sectional shape matching a cross-sectional shape of the hollow of the cartridge, and the passage extending longitudinally through the body of the end block and aligned with the hollow of the cartridge to movably receive the strap therein;
k) a shuttle slidably disposed in each hollow of each cartridge at each end and slidable between the spring block and the end block, and operatively coupled to the spring to be biased towards the spring block, the shuttle including a body with a cross-sectional shape matching a cross-sectional shape of the hollow of the cartridge, a slot in the body of the shuttle to receive the strap with an enlarged cavity to receive an end of the strap and a wedge therein, and an opposite slot to receive an end of the spring;
l) a strap coupled between the handle and the shuttle on each side of the handle; and
m) the handle being removable from the shelf of the backboard and drawing the strap from the cartridge and displacing the shuttle in the hollow towards the open end against the spring so that the backboard can be suspended from the handle and the strap, and the handle being replaceable on the shelf with the spring drawing the shuttle towards the spring block along with the strap.
